(19) United States
(12) Patent Application Publication
(10) Pub. No.: US 2026/0243918 A1
(43) Pub. Date: Aug. 20, 2026

(54) METHOD FOR PREDICTING RECOVERY FACTOR OF DEEP COALBED METHANE

(71) Applicants: Xi’an Shiyou University, Xi'an (CN); China University of Petroleum (Beijing), Beijing (CN)

(72) Inventors: Juntai Shi, Beijing (CN); Hai Huang, Xi'an (CN); Ming Chen, Wuhan (CN); Hongxing Huang, Beijing (CN); Xianyue Xiong, Beijing (CN); Wentong Zhang, Xianyang (CN); Yitianyu Ji, Neijiang (CN); Kai Wang, Xi'an (CN); Shuo Zhang, Nenjiang (CN)

(21) Appl. No.: 19/445,649

(22) Filed: Jan. 12, 2026

(30) Foreign Application Priority Data
Feb. 18, 2025 (CN) 202510177363.0

(51) Int. Cl. G01V 20/00

(52) U.S. Cl. CPC G01V 20/00

(57) ABSTRACT

A method for predicting a recovery factor of deep coalbed methane includes: determining physical parameters, a capillary pressure, corrected values of reservoir porosity and water saturation, average coal reservoir pressure, cumulative water production, and conventional average gas deviation factor at multiple production dates; calculating an actual average gas deviation factor; establishing a prediction model for gas production of a reservoir; calculating an iterative value of a control volume; returning the iterative value to replace an initially given value of the control volume for loop calculation, determining a first relationship model between the cumulative water production and the average coal reservoir pressure; determining, based on the first relationship model, a predicted value on the vertical axis of the prediction model; and substituting the predicted value into a prediction model established in a last iteration of the loop calculation to obtain a recoverable reserve of coalbed methane, and calculating the recovery factor.

### CROSS-REFERENCE TO RELATED APPLICATION

This application claims priority to Chinese Patent Application No. 202510177363.0, filed on Feb. 18, 2025, which is herein incorporated by reference in its entirety.

### TECHNICAL FIELD

The disclosure relates to the field of coalbed methane development technologies, and more particularly to a method for predicting the recovery factor of deep coalbed methane.

### BACKGROUND

Coalbed methane, commonly known as “gas”, is an unconventional natural gas that coexists with coal and is predominantly stored in coal seams in an adsorbed state. Deep coalbed methane refers to natural gas stored in coal seams with a burial depth exceeding 1,500 meters (m), which not only contains adsorbed gas but also contains free gas and dissolved gas.

However, the recovery factor of the deep coalbed methane is unclear, and there is a lack of methods for predicting the recovery factor of the deep coalbed methane. Accurately predicting the recovery factor of coalbed methane has theoretical guiding significance for comparing and evaluating development effectiveness of single wells under different production technology, selecting optimal approaches to improve the recovery factor of coalbed methane, and ultimately achieving efficient development of the deep coalbed methane.

Currently, methods for predicting recoverable reserves and recovery factors of the deep coalbed methane mostly rely on a principle of production decline, which are empirical methods. However, the deep coalbed methane possesses characteristics of adsorption and desorption. Conventional decline analysis methods do not consider influence of the adsorption and the desorption. Such methods are applicable to deep coalbed methane wells in a production decline stage but are not suitable for those in a production increase stage and a steady production stage, leading to low reliability in predictions.

### SUMMARY

In view of the aforementioned defects or shortcomings in related art, the disclosure provides a method for predicting the recovery factor of deep coalbed methane, aiming to solve a technical problem of low reliability in predictions caused by prediction methods in the art for recovery factors being based on a principle of production decline.

To achieve the aforementioned objectives, the disclosure provides a method for predicting the recovery factor of the deep coalbed methane. The method for predicting the recovery factor of the deep coalbed methane includes the following steps:
determining physical parameters of a reservoir and fluid, respectively;
determining an average coal reservoir pressure, a cumulative gas production, and a cumulative water production at multiple production dates, and determining a conventional average gas deviation factor based on the average coal reservoir pressure;
determining a capillary pressure between micropores and mesopores in the reservoir;
determining, based on an initially given value of a control volume, a corrected value of reservoir porosity and a corrected value of water saturation after fracturing flowback but before production;
calculating an actual average gas deviation factor based on the physical parameters, the capillary pressure, the initially given value of the control volume, the corrected value of reservoir porosity, the corrected value of water saturation, the average coal reservoir pressure, the cumulative water production, and the conventional average gas deviation factor at the multiple production dates;
establishing a prediction model for gas production of the reservoir using the cumulative gas production as a horizontal axis and a ratio of the average coal reservoir pressure to the actual average gas deviation factor as a vertical axis, and determining an original gas in place of the reservoir based on the prediction model for the gas production of the reservoir;
calculating an iterative value of the control volume based on the physical parameters, the capillary pressure, the corrected value of reservoir porosity, the corrected value of water saturation, and the original gas in place of the reservoir; returning the iterative value of the control volume to replace the initially given value of the control volume for loop calculation; and stopping the loop calculation when a difference between values of the control volume from two adjacent iterations of the loop calculation is less than a preset value;
determining a first relationship model between the cumulative water production and the average coal reservoir pressure, and determining, based on the first relationship model, a predicted value on the vertical axis of the prediction model under a given abandonment pressure; and
substituting the predicted value on the vertical axis into a prediction model established in a last iteration of the loop calculation to obtain a recoverable reserve of coalbed methane, and calculating the recovery factor.

In an embodiment, the method for predicting the recovery factor of the deep coalbed methane further includes mining the coalbed methane in a deep coalbed methane well based on the recoverable reserve of coalbed methane and the recovery factor. Specifically, the recoverable reserve of coalbed methane and the recovery factor can be used to establish a dynamic reservoir management model for coalbed methane, and the dynamic reservoir management model can be displayed on a display, thereby facilitating researchers or engineers monitoring and adjusting reservoir production behavior. Moreover, the method for predicting the recovery factor of the deep coalbed methane provided by the disclosure can be encapsulated as a functional module in a gas field development software and integrated into reservoir management platforms for recoverable reserves evaluation. Within the gas field development software, this prediction method can automatically read well logging, fracturing operation, and well testing data imported by researchers or engineers and drive a computational workflow to achieve fully automated processing from raw data input to output of the recoverable reserve and recovery factor.

In an embodiment, the calculating an actual average gas deviation factor based on the physical parameters, the capillary pressure, the initially given value of the control volume, the corrected value of reservoir porosity, the corrected value of water saturation, the average coal reservoir pressure, the cumulative water production, and the conventional average gas deviation factor at the multiple production dates includes:
substituting the physical parameters, the capillary pressure, the initially given value of the control volume, the corrected value of reservoir porosity, the corrected value of water saturation, the average coal reservoir pressure, the cumulative water production, and the conventional average gas deviation factor into a sixth calculation formula to calculate the actual average gas deviation factor at the multiple production dates, in which the sixth calculation formula is expressed as follows:

$${Z}^{*} = {( \begin{matrix}\frac{{p}_{sc} T {ρ}_{c} {V}_{L} ( p + {p}_{c} )}{{ϕ}_{ip} {Z}_{sc} {T}_{sc} p ( {p}_{L} + p + {p}_{c} )} + \frac{{p}_{sc} T {C}_{s} ( {S}_{wip} + {S}_{wip} {C}_{w} ( {p}_{i} - p ) + \frac{{W}_{e} - {W}_{p} {B}_{w}}{V {ϕ}_{ip}} )}{{Z}_{sc} {T}_{sc}} + \\ \frac{1 - {S}_{wip} - ( {C}_{p} + {S}_{wip} {C}_{w} ) ( {p}_{i} - p ) + {C}_{a} ( \frac{{p}_{i} + {p}_{c}}{{p}_{L} + {p}_{i} + {p}_{c}} - \frac{p + {p}_{c}}{{p}_{L} + p + {p}_{c}} ) - \frac{{W}_{e} - {W}_{p} {B}_{w}}{V {ϕ}_{ip}}}{Z}\end{matrix} )}^{- 1}$$

where Z* represents the actual average gas deviation factor, dimensionless; ρ_{c} represents a density of coal rock, tons per cubic meter (t/m³); V_{L} represents a Langmuir volume, cubic meters per ton (m³/t); P_{L} represents a Langmuir pressure, megapascal (MPa); p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc} represents a conventional gas deviation factor under a standard condition, dimensionless, with a value of 1; T_{sc} represents a temperature under the standard condition, Kelvin (K), with a value of 293.15; pᵢ represents an initial coal reservoir pressure, MPa; p_{sc} represents a pressure under the standard condition, MPa, with a value of 0.101325; T represents a coal reservoir temperature, K; p represents the average coal reservoir pressure, MPa; Z represents the conventional average gas deviation factor, dimensionless; Cₚ represents a pore compressibility, per megapascal (MPa⁻¹); C_{w} represents an isothermal compressibility of water, MPa⁻¹; Cₛ represents a solubility coefficient of the coalbed methane in water, MPa⁻¹; Cₐ represents a coal matrix shrinkage coefficient, dimensionless; Wₑ represents a cumulative water influx, 10⁶ cubic meter (m³), with a value of 0; Wₚ represents the cumulative water production, 10⁶ m³; B_{w} represents a volume coefficient of the water, cubic meter per cubic meter (m³/m³), with a value of 1; and V represents the initially given value of the control volume, 10⁶ m³.

In an embodiment, the determining a first relationship model between the cumulative water production and the average coal reservoir pressure, and determining, based on the first relationship model, a predicted value on the vertical axis of the prediction model under a given abandonment pressure includes:
substituting the cumulative water production and the average coal reservoir pressure corresponding to a last production date of the multiple production dates, and the iterative value of the control volume, the corrected value of reservoir porosity, and the corrected value of water saturation obtained in the last iteration of the loop calculation into a tenth calculation formula to obtain the first relationship model, in which the tenth calculation formula is expressed as follows:

$${W}_{p} = {W}_{ps} + \frac{( V {ϕ}_{ip} {S}_{wip} {R}_{w} - {W}_{ps} ) \cdot ( {p}_{s} - p )}{( 2.5 + {p}_{s} - p )} ;$$

where, Wₚ represents the cumulative water production, 10⁶ m³; p represents the average coal reservoir pressure, MPa; Wₚₛ represents the cumulative water production corresponding to the last production date of the multiple production dates, 10⁶ m³; pₛ represents the average coal reservoir pressure corresponding to the last production date of the multiple production dates, MPa; V represents the iterative value of the control volume obtained in the last iteration of the loop calculation, 10⁶ m³; φᵢₚ represents the corrected value of reservoir porosity obtained in the last iteration of the loop calculation, decimal; S_{wip} represents the corrected value of water saturation obtained in the last iteration of the loop calculation, decimal; and R_{w} represents a recovery factor of water, with a value of 35%; and
determining, based on the first relationship model, the predicted value on the vertical axis of the prediction model under the given abandonment pressure.

In an embodiment, the determining, based on the first relationship model, the predicted value on the vertical axis of the prediction model under the given abandonment pressure includes:
substituting the given abandonment pressure as the average coal reservoir pressure into the first relationship model to calculate a cumulative water production under the given abandonment pressure;
substituting the given abandonment pressure as the average coal reservoir pressure and the cumulative water production under the given abandonment pressure into the sixth calculation formula to obtain an actual average gas deviation factor under the given abandonment pressure; and
determining a ratio of the given abandonment pressure to the actual average gas deviation factor under the given abandonment pressure as the predicted value on the vertical axis of the prediction model under the given abandonment pressure.

In an embodiment, the determining, based on the first relationship model, the predicted value on the vertical axis of the prediction model under the given abandonment pressure includes:
substituting a given pressure value lower than the average coal reservoir pressure corresponding to the last production date of the multiple production dates as the average coal reservoir pressure into the first relationship model to calculate a cumulative water production at the given pressure value;
substituting the given pressure value and the cumulative water production at the given pressure value into the sixth calculation formula to obtain an actual average gas deviation factor at the given pressure value;
establishing a second relationship model using the given pressure value serving as the average coal reservoir pressure as a horizontal axis and a ratio of the given pressure value to the actual average gas deviation factor at the given pressure value as a vertical axis; and
substituting the given abandonment pressure as the average coal reservoir pressure into the second relationship model to obtain the predicted value on the vertical axis of the prediction model under the given abandonment pressure.

In an embodiment, the determining a capillary pressure between micropores and mesopores in the reservoir includes:
determining, based on a first calculation formula, the capillary pressure between the micropores and the mesopores in the reservoir, in which the first calculation formula is expressed as follows:

$${p}_{c} = 2 ( \frac{1}{d} - \frac{1}{D} ) {σ}_{gw} cos θ ;$$

where, p_{c} represents the capillary pressure between the micropores and the mesopores in the reservoir, MPa; d represents an average pore diameter of the micropores in the coal matrix, nanometers (nm); D represents an average pore diameter of the mesopores in the coal matrix, nm; σ_{gw} represents an interfacial tension between gas and water, millinewtons per meter (mN/m); and θ represents a wetting angle of a surface of the coal matrix, degree (°).

In an embodiment, the determining, based on an initially given value of a control volume, a corrected value of reservoir porosity and a corrected value of water saturation after fracturing flowback but before production includes:
substituting the initially given value of the control volume into a fourth calculation formula and a fifth calculation formula, respectively, to calculate the corrected value of reservoir porosity and the corrected value of water saturation after fracturing flowback but before production, in which the fourth calculation formula is expressed as follows:

$${ϕ}_{ip} = {ϕ}_{i} + \frac{{W}_{fin} {B}_{w}}{V} ;$$

where φᵢₚ represents the corrected value of reservoir porosity, decimal; φᵢ represents an initial porosity of a coal reservoir, decimal; W_{fin} represents a net fracturing injection volume, 10⁶ m³; B_{w} represents the volume coefficient of water, m³/m³, with a value of 1; and V represents the initially given value of the control volume, 10⁶ m³; and
in which the fifth calculation formula is expressed as follows:

$${S}_{wip} = \frac{{ϕ}_{i} {s}_{wi} + \frac{{W}_{fin} {B}_{w}}{V}}{{ϕ}_{ip}} ;$$

where S_{wip} represents the corrected value of water saturation, decimal; φᵢ represents the initial porosity of the coal reservoir, decimal; W_{fin} represents the net fracturing injection volume, 10⁶ m³; B_{w} represents the volume coefficient of water, m³/m³, with a value of 1; and φᵢₚ represents the corrected value of reservoir porosity, decimal.

In an embodiment, before determining, based on the initially given value of the control volume, the corrected value of reservoir porosity and the corrected value of water saturation after fracturing flowback but before production, the method for predicting the recovery factor of the deep coalbed methane further includes:
substituting a total fracturing fluid volume during a fracturing process and a cumulative flowback volume during a flowback process into a third calculation formula to obtain the net fracturing injection volume, in which the third calculation formula is expressed as follows:

$${W}_{fin} = {W}_{fi} - {W}_{fp} ;$$

where W_{fin} represents the net fracturing injection volume, 10⁶ m³; W_{fi} represents the total fracturing fluid volume during the fracturing process, 10⁶ m³; and W_{fp} represents the cumulative flowback volume during the flowback process, 10⁶ m³.

In an embodiment, the calculating an iterative value of the control volume based on the physical parameters, the capillary pressure, the corrected value of reservoir porosity, the corrected value of water saturation, and the original gas in place of the reservoir; returning the iterative value of the control volume to replace the initially given value of the control volume for loop calculation; and stopping the loop calculation when a difference between values of the control volume from two adjacent iterations of the loop calculation is less than a preset value includes:
substituting the physical parameters, the capillary pressure, the corrected value of reservoir porosity, the corrected value of water saturation, and the original gas in place of the reservoir into an eighth calculation formula to calculate the iterative value of the control volume, in which the eighth calculation formula is expressed as follows:

$$V = \frac{{G}_{i}}{[ {ρ}_{c} \frac{{V}_{L} ( {p}_{i} + {p}_{c} )}{{p}_{L} + {p}_{i} + {p}_{c}} + \frac{{ϕ}_{ip} ( 1 - {s}_{wip} ) {z}_{sc} {T}_{sc} {p}_{i}}{{p}_{sc} {Z}_{i} T} + {ϕ}_{ip} {S}_{wip} {C}_{s} {p}_{i} ]} ;$$

where V represents the iterative value of the control volume, 10⁶ m³; Gᵢ represents the original gas in place of the reservoir, 10⁶ m³; ρ_{c} represents the density of coal rock, t/m³; V_{L} represents the Langmuir volume, m³/t; p_{L} represents the Langmuir pressure, MPa; p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc}, represents the conventional gas deviation factor under the standard condition, dimensionless, with the value of 1; T_{sc} represents the temperature under the standard condition, K, with the value of 293.15; p_{sc} represents the pressure under the standard condition, MPa, with the value of 0.101325; pᵢ represents the initial coal reservoir pressure, MPa; T represents the coal reservoir temperature, K; Zᵢ represents a conventional gas deviation factor under the initial coal reservoir pressure, dimensionless; and Cₛ represents the solubility coefficient of the coalbed methane in the water, MPa⁻¹; and
returning the iterative value of the control volume to replace the initially given value of the control volume for the loop calculation, and stopping the loop calculation when the difference between the values of the control volume from two adjacent iterations of the loop calculation is less than the preset value.

In an embodiment, the substituting the predicted value on the vertical axis into a prediction model established in a last iteration of the loop calculation to obtain a recoverable reserve of coalbed methane, and calculating the recovery factor includes:
substituting the predicted value on the vertical axis into the prediction model established in the last iteration of the loop calculation to obtain the recoverable reserve of the coalbed methane; and
substituting the recoverable reserve and an original gas in place of the reservoir obtained in the last iteration of the loop calculation into a twelfth calculation formula to calculate the recovery factor of the coalbed methane, in which the twelfth calculation formula is expressed as follows:

$${R}_{cbm} = \frac{{G}_{pab}}{{G}_{i}} ;$$

where R_{cbm} represents the recovery factor of the deep coalbed methane, G_{pab} represents the recoverable reserve of the deep coalbed methane, 10⁶ m³; and Gᵢ represents the original gas in place of the reservoir, 10⁶ m³.

Through the aforementioned technical solutions, the method for predicting the recovery factor of the deep coalbed methane provided by the disclosure has the following beneficial effects.

In the aforementioned technical solutions, the physical parameters of the reservoir and the fluid, the capillary pressure between the micropores and the mesopores in the reservoir, the initially given value of the control volume, the corrected value of reservoir porosity and the corrected value of water saturation after fracturing flowback but before production, and the average coal reservoir pressure, the cumulative water production, and the conventional average gas deviation factor at the multiple production dates are firstly determined. The actual average gas deviation factor is secondly calculated based on the aforementioned parameters. Thirdly, the prediction model for the gas production of the reservoir is established using the cumulative gas production as the horizontal axis and the ratio of the average coal reservoir pressure to the actual average gas deviation factor as the vertical axis, and the original gas in place of the reservoir is determined based on the prediction model for the gas production of the reservoir. Fourthly, the iterative value of the control volume is calculated based on the physical parameters, the capillary pressure, the corrected value of reservoir porosity, the corrected value of water saturation, and the original gas in place of the reservoir; the iterative value of the control volume is returned to replace the initially given value of the control volume for the loop calculation; and the loop calculation is stopped when the difference between the values of the control volume from two adjacent iterations of the loop calculation is less than the preset value. Fifthly, the first relationship model between the cumulative water production and the average coal reservoir pressure is determined, and the predicted value on the vertical axis of the prediction model under the given abandonment pressure is determined based on the first relationship model. Ultimately, the predicted value on the vertical axis is substituted into the prediction model established in the last iteration of the loop calculation to obtain the recoverable reserve of the coalbed methane, and the recovery factor is calculated. Due to inclusion of the capillary pressure between the micropores and the mesopores in the reservoir and the corrected value of reservoir porosity and the corrected value of water saturation after fracturing flowback but before production, and the solubility coefficient of the coalbed methane in the water among the physical parameters in calculation of the actual average gas deviation factor, the actual average gas deviation factor comprehensively takes a pressure difference between adsorbed gas pores and free gas pores and impact of fracturing modification on changes in the physical parameters of the coal reservoir and dissolved gas into account. The method for predicting the recovery factor of the deep coalbed methane provided by the disclosure is not only applicable to deep coalbed methane wells in a production decline stage, but also applicable to deep coalbed methane wells in a production increase stage and a steady production stage, making subsequently obtained recoverable reserve of the coalbed methane and calculation of the recovery factor more accurate, thereby achieving the objective of improving the reliability in the predictions.

Other features and advantages of embodiments of the disclosure will be described in detail in the following section of DETAILED DESCRIPTION OF EMBODIMENTS.

### BRIEF DESCRIPTION OF DRAWINGS

Attached drawings are intended to provide a further understanding of embodiments of the disclosure, constitute a part of the specification, and, together with the following detailed embodiments, serve to explain the disclosure, but do not constitute a limitation on the embodiments of the disclosure.

FIG. 1 illustrates a flowchart of a method for predicting a recovery factor of deep coalbed methane according to an embodiment of the disclosure.

FIG. 2 illustrates an initial view of a prediction model for gas production of a reservoir according to an embodiment of the disclosure.

FIG. 3 illustrates a final view of the prediction model for the gas production of the reservoir according to an embodiment of the disclosure.

FIG. 4 illustrates a schematic view of a first relationship model between Wₚ and p.

FIG. 5 illustrates a schematic view of a second relationship model between p/Z* and p.

FIG. 6 illustrates a schematic view of prediction results of

$${p}_{a b} / {Z}_{a b}^{*}$$

under different abandonment pressures p_{ab}.

FIG. 7 illustrates a schematic view of prediction results of a recoverable reserve G_{pab} under different

$${p}_{a b} / {Z}_{a b}^{*} .$$

### DETAILED DESCRIPTION OF EMBODIMENTS

Specific implementation methods of embodiments of the disclosure will be described in detail as follows with reference to attached drawings. It should be understood that the specific implementation methods described herein are only used to illustrate and explain the embodiments of the disclosure and are not intended to limit the embodiments of the disclosure.

It should be noted that, when directional indications (such as up, down, left, right, front, back, etc.) are involved in the embodiments of the disclosure, the directional indications are only used to explain relative position relationship and motion of each component in a specific posture (as shown in the attached drawings). When the specific posture changes, the directional indications also change accordingly.

In addition, when descriptions of “first”, “second”, etc. are involved in the embodiments of the disclosure, the descriptions of “first”, “second”, etc. are only for descriptive purposes and cannot be understood as indicating or implying their relative importance or implying a number of technical features indicated. Therefore, features limited by “first” and “second” can explicitly or implicitly include at least one of these features. Moreover, technical solutions in various implementation methods can be combined with each other, but a combination must be based on realization of those skilled in the art. When the combination of the technical solutions is contradictory or impossible to achieve, it should be considered that this combination of technical solutions does not exist and is not within a scope of protection of the disclosure.

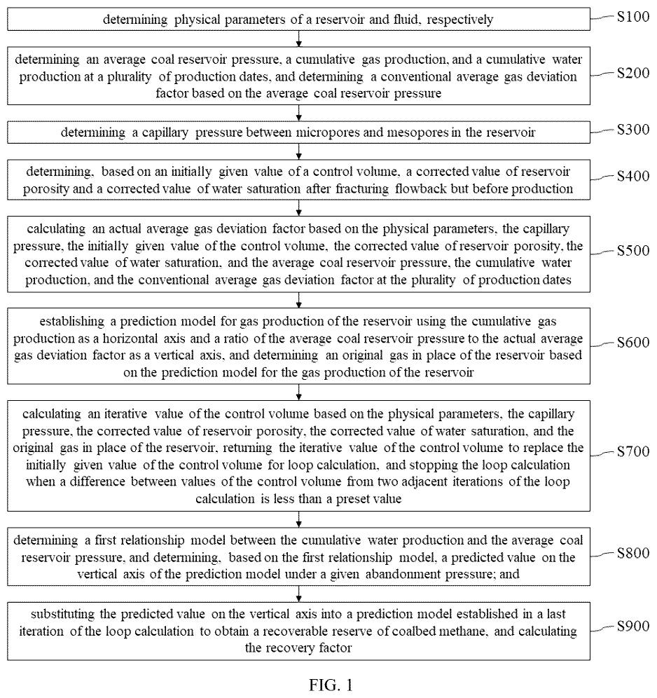

FIG. 1 schematically illustrates a flowchart of a method for predicting a recovery factor of deep coalbed methane according to an embodiment of the disclosure. As illustrated in FIG. 1, the method for predicting the recovery factor of the deep coalbed methane provided by the disclosure includes the following step S100 through step S900.

Step S100, physical parameters of a reservoir and fluid are determined, respectively.

Specifically, the physical parameters of the reservoir and the physical parameters of the fluid are organized and statistically analyzed. The physical parameters of the reservoir include: density of coal rock ρ_{c}, initial porosity of a coal reservoir φᵢ, initial coal reservoir pressure pᵢ, coal reservoir temperature T, initial water saturation of the coal reservoir S_{wi}, pore compressibility Cₚ, average pore diameter of micropores in coal matrix d, average pore diameter of mesopores in the coal matrix D, wetting angle of a surface of the coal matrix θ, coal matrix shrinkage coefficient Cₐ, Langmuir volume of adsorbed gas V_{L}, and Langmuir pressure of the adsorbed gas p_{L}. The physical parameters of the fluid include: specific gravity of natural gas γ_{g}, conventional gas deviation factor under the initial coal reservoir pressure Zᵢ, volume coefficient of water B_{w}, isothermal compressibility of water C_{w}, solubility coefficient of coalbed methane in water Cₛ, and interfacial tension between gas and the water σ_{gw}.

Step S200, an average coal reservoir pressure, a cumulative gas production, and a cumulative water production at multiple production dates are determined. A conventional average gas deviation factor is determined based on the average coal reservoir pressure.

Further, the average coal reservoir pressure, the cumulative gas production, and the cumulative water production at the multiple production dates are organized and statistically analyzed according to production dates. A cumulative water influx during a production process is generally 0. At the same time, the conventional average gas deviation factor can be determined according to the average coal reservoir pressure. Specifically, a Dranchuk-Abo-Kassem method is applied to obtain the conventional average gas deviation factor under the average coal reservoir pressure corresponding to each of the production dates based on the specific gravity of the natural gas γ_{g} and the coal reservoir temperature T. It should be particularly noted that a measured average coal reservoir pressure generally is a pressure detected inside larger pores (such as cleat fractures, macropores, and mesopores). Therefore, the conventional average gas deviation factor determined based on the average coal reservoir pressure mainly characterizes the larger pores and ignores micropores.

Step S300, a capillary pressure between the micropores and the mesopores in the reservoir is determined.

Specifically, the adsorbed gas in the deep coalbed methane is mainly stored in the micropores (pore diameter less than 2 nm) of the coal matrix, while free gas, dissolved gas, and the water are stored in the cleat fractures (pore diameter greater than 1000 nm), the macropores (pore diameter between 50 nm and 1000 nm), and the mesopores (pore diameter between 2 nm and 50 nm). The initial coal reservoir pressure is actually a pressure within the cleat fractures, the macropores, and the mesopores of the coal reservoir. To subsequently calculate the actual average gas deviation factor that characterizes all pores, the capillary pressure between the micropores and the mesopores in the reservoir can be determined first.

In an embodiment of the disclosure, the step S300 of determining the capillary pressure between the micropores and the mesopores in the reservoir includes determining, based on a first calculation formula, the capillary pressure between the micropores and the mesopores in the reservoir, in which the first calculation formula is expressed as follows:

$${p}_{c} = 2 ( \frac{1}{d} - \frac{1}{D} ) {σ}_{g w} cos θ ;$$

where p_{c} represents the capillary pressure between the micropores and the mesopores in the reservoir, MPa; d represents the average pore diameter of the micropores in the coal matrix, nm; D represents the average pore diameter of the mesopores in the coal matrix, nm; σ_{gw} represents the interfacial tension between the gas and the water, mN/m; and θ represents the wetting angle of the surface of the coal matrix, °.

More specifically, parameters in the first calculation formula, except for p_{c}, are all known physical parameters, from which the capillary pressure can be calculated. Moreover, when the initial coal reservoir pressure pᵢ is known, an initial pressure pₘᵢ in the micropores of the coal reservoir can also be calculated according to a second calculation formula. The second calculation formula is expressed as follows:

$${p}_{m i} = {p}_{i} + {p}_{c}$$

where pₘᵢ represents the initial pressure in the micropores of the coal reservoir, MPa; pᵢ represents the initial coal reservoir pressure, MPa; and p_{c} represents the capillary pressure between the micropores and the mesopores in the reservoir, MPa.

Step S400, a corrected value of reservoir porosity and a corrected value of water saturation after fracturing flowback but before production are determined based on an initially given value of a control volume.

Specifically, based on the initially given value of the control volume, calculation formulas are established for the corrected value of reservoir porosity and the corrected value of water saturation after fracturing flowback but before production. By substituting the initially given value of the control volume and other known parameters into the calculation formulas, the corrected value of reservoir porosity and the corrected value of water saturation can be calculated.

In an embodiment, before determining the corrected value of reservoir porosity and the corrected value of water saturation after fracturing flowback but before production based on the initially given value of the control volume, the method for predicting the recovery factor of the deep coalbed methane further includes substituting a total fracturing fluid volume during a fracturing process and a cumulative flowback volume during a flowback process into a third calculation formula to obtain a net fracturing injection volume. The third calculation formula is expressed as follows:

$${W}_{f i n} = {W}_{f i} - {W}_{f p} ;$$

where W_{fin} represents the net fracturing injection volume, 10⁶ m³; W_{fi} represents the total fracturing fluid volume during the fracturing process, 10⁶ m³; and W_{fp} represents the cumulative flowback volume during the flowback process, 10⁶ m³.

More specifically, the total fracturing fluid volume during the fracturing process and the cumulative flowback volume during the flowback process can be obtained through statistical analysis.

In an embodiment, the step S400 of determining the corrected value of reservoir porosity and the corrected value of water saturation after fracturing flowback but before production based on the initially given value of the control volume includes substituting the initially given value of the control volume into a fourth calculation formula and a fifth calculation formula, respectively, to calculate the corrected value of reservoir porosity and the corrected value of water saturation after fracturing flowback but before production. The fourth calculation formula is expressed as follows:

$${ϕ}_{i p} = {ϕ}_{i} + \frac{{W}_{f i n} {B}_{w}}{V} ,$$

where φᵢₚ represents the corrected value of reservoir porosity, decimal; φᵢ represents the initial porosity of the coal reservoir, decimal; W_{fin} represents the net fracturing injection volume, 10⁶ m³; B_{w} represents the volume coefficient of water, m³/m³, with a value of 1; and V represents the initially given value of the control volume, 10⁶ m³; and
the fifth calculation formula is expressed as follows:

$${S}_{w i p} = \frac{{ϕ}_{i} {S}_{w i} + \frac{{W}_{f i n} {B}_{W}}{V}}{{ϕ}_{i p}} ,$$

where S_{wip} represents the corrected value of water saturation, decimal; φᵢ represents the initial porosity of the coal reservoir, decimal; W_{fin} represents the net fracturing injection volume, 10⁶ m³; B_{w} represents the volume coefficient of water, m³/m³, with a value of 1; and φᵢₚ represents the corrected value of reservoir porosity, decimal.

More specifically, the initially given value of the control volume can be determined based on geological knowledge, which can be equal to a product of a length of a horizontal section of a coalbed methane well, a distance among horizontal wells, and a thickness of a deep coal reservoir. The above φᵢₚ and S_{wip} are both obtained by considering impact of fracturing modification on a reservoir porosity and a water saturation.

Step S500, an actual average gas deviation factor is calculated based on the physical parameters, the capillary pressure, the initially given value of the control volume, the corrected value of reservoir porosity, the corrected value of water saturation, and the average coal reservoir pressure, the cumulative water production, and the conventional average gas deviation factor at the multiple production dates.

Specifically, a calculation formula for the actual average gas deviation factor can be designed based on a principle of material balance of deep coalbed methane reservoirs, and this calculation formula includes the physical parameters, the capillary pressure, the initially given value of the control volume, the corrected value of reservoir porosity, the corrected value of water saturation, and the average coal reservoir pressure, the cumulative water production, and the conventional average gas deviation factor at the multiple production dates obtained in previous steps. In particular, the physical parameters include the solubility coefficient of coalbed methane in the water, so that the actual average gas deviation factor comprehensively considers a pressure difference between adsorbed gas pores and free gas pores and impact of fracturing modification on changes in the physical parameters of the coal reservoir and dissolved gas. Compared with the conventional average gas deviation factor, the actual average gas deviation factor obviously makes subsequent calculations more accurate.

In an embodiment, the step S500 of calculating the actual average gas deviation factor based on the physical parameters, the capillary pressure, the initially given value of the control volume, the corrected value of reservoir porosity, the corrected value of water saturation, and the average coal reservoir pressure, the cumulative water production, and the conventional average gas deviation factor at the multiple production dates includes:
substituting the physical parameters, the capillary pressure, the initially given value of the control volume, the corrected value of reservoir porosity, the corrected value of water saturation, the average coal reservoir pressure, the cumulative water production, and the conventional average gas deviation factor into a sixth calculation formula to calculate the actual average gas deviation factor at the multiple production dates, in which the sixth calculation formula is expressed as follows:

$${Z}^{*} = {( \begin{matrix}\begin{matrix}\frac{{p}_{sc} T {ρ}_{c} {V}_{L} ( p + {p}_{c} )}{{ϕ}_{ip} {Z}_{sc} {T}_{sc} p ( {p}_{L} + p + {p}_{c} )} + \\ \frac{{p}_{sc} {TC}_{s} ( {S}_{wip} + {S}_{wip} {C}_{w} ( {p}_{i} - p ) + \frac{{W}_{e} - {W}_{p} {B}_{w} )}{V {ϕ}_{ip}} )}{{Z}_{sc} {T}_{sc}} +\end{matrix} \\ \frac{\begin{matrix}1 - {S}_{wip} - ( {C}_{p} + {S}_{wip} {C}_{w} ) ( {p}_{i} - p ) + \\ {C}_{a} ( \frac{{p}_{i} + {p}_{c}}{{p}_{L} + {p}_{i} + {p}_{c}} - \frac{p + {p}_{c}}{{p}_{L} + p + {p}_{c}} ) - \frac{{W}_{e} - {W}_{p} {B}_{w}}{V {ϕ}_{ip}}\end{matrix}}{Z}\end{matrix} )}^{- 1}$$

where Z* represents the actual average gas deviation factor, dimensionless; ρ_{c} represents the density of coal rock, t/m³; V_{L} represents the Langmuir volume, m³/t; p_{L} represents the Langmuir pressure, MPa; p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc} represents a conventional gas deviation factor under a standard condition, dimensionless, with a value of 1; T_{sc} represents a temperature under the standard condition, K, with a value of 293.15; pᵢ represents the initial coal reservoir pressure, MPa; p_{sc} represents a pressure under the standard condition, MPa, with a value of 0.101325; T represents the coal reservoir temperature, K; p represents the average coal reservoir pressure, MPa; Z represents the conventional average gas deviation factor, dimensionless; Cₚ represents the pore compressibility, MPa⁻¹; C_{w} represents the isothermal compressibility of water, MPa⁻¹; Cₛ represents the solubility coefficient of the coalbed methane in the water, MPa⁻¹; Cₐ represents the coal matrix shrinkage coefficient, dimensionless; Wₑ represents the cumulative water influx, 10⁶ m³, with a value of 0; Wₚ represents the cumulative water production, 10⁶ m³; B_{w} represents the volume coefficient of the water, m³/m³, with a value of 1; and V represents the initially given value of the control volume, 10⁶ m³.

Step S600, a prediction model for gas production of the reservoir is established using the cumulative gas production as a horizontal axis and a ratio of the average coal reservoir pressure to the actual average gas deviation factor as a vertical axis. An original gas in place of the reservoir is determined based on the prediction model for the gas production of the reservoir.

Specifically, a scatter plot is drawn in a Cartesian coordinate system by using the cumulative gas production Gₚ as the horizontal axis and the ratio of p/Z* as the vertical axis. By using linear fitting, a slope value −M and a Y-axis intercept value N of a linear trend line can be obtained. The original gas in place of the reservoir of the deep coalbed methane can be calculated according to a seventh calculation formula; this value is just an initial value, and a final value of the original gas in place of the reservoir can be obtained by iteratively calculation. The seventh calculation formula is

$${G}_{i} = \frac{N}{M} .$$

Step S700, an iterative value of the control volume is calculated based on the physical parameters, the capillary pressure, the corrected value of reservoir porosity, the corrected value of water saturation, and the original gas in place of the reservoir. The iterative value is returned to replace the initially given value of the control volume for loop calculation. The loop calculation is stopped when a difference between values of the control volume from two adjacent iterations of the loop calculation is less than a preset value.

Further, the aforementioned initially given value of the control volume is roughly calculated. To improve accuracy of the control volume, an iterative operation method is used to approximate an accurate result through multiple repeated calculations. Furthermore, a calculation formula for the iterative value of the control volume can be established based on the physical parameters, the capillary pressure, the corrected value of reservoir porosity, the corrected value of water saturation, and the original gas in place of the reservoir. Values of the aforementioned parameters are substituted into the calculation formula for the iterative value of the control volume to calculate the iterative value. An iterative value obtained in a first iteration of the loop calculation is returned to the step S400 and replaces the initially given value in the step S400 for the loop calculation from step S400 to step S700. During each iteration of the loop calculation, not only the control volume will be updated, but also the corrected value of reservoir porosity, the corrected value of water saturation, the actual average gas deviation factor, the prediction model for the gas production of the reservoir, and the original gas in place of the reservoir will be updated. At the same time, the loop calculation is stopped when the difference between the values of the control volume from two adjacent iterations of the loop calculation is less than the preset value.

In an embodiment, the step S700 of calculating the iterative value of the control volume based on the physical parameters, the capillary pressure, the corrected value of reservoir porosity, the corrected value of water saturation, and the original gas in place of the reservoir; returning the iterative value of the control volume to replace the initially given value of the control volume for loop calculation; and stopping the loop calculation when the difference between the values of the control volume from two adjacent iterations of the loop calculation is less than the preset value includes step S710 through step S720.

Step S710, the physical parameters, the capillary pressure, the corrected value of reservoir porosity, the corrected value of water saturation, and the original gas in place of the reservoir are substituted into an eighth calculation formula to calculate the iterative value of the control volume, in which the eighth calculation formula is expressed as follows:

$$V = \frac{{G}_{i}}{[ {ρ}_{c} \frac{{V}_{L} ( {p}_{i} + {p}_{c} )}{{p}_{L} + {p}_{i} + {p}_{c}} + \frac{{ϕ}_{i p} ( 1 - {S}_{w i p} ) {Z}_{sc} {T}_{s c} {p}_{i}}{{p}_{s c} {Z}_{i} T} + {ϕ}_{ip} {S}_{wip} {C}_{s} {p}_{i} ]} ;$$

where V represents the iterative value of the control volume, 10⁶ m³; Gᵢ represents the original gas in place of the reservoir, 10⁶ m³; ρ_{c} represents the density of coal rock, t/m³; V_{L} represents the Langmuir volume, m³/t; p_{L} represents the Langmuir pressure, MPa; p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc} represents the conventional gas deviation factor under the standard condition, dimensionless, with the value of 1; T_{sc} represents the temperature under the standard condition, K, with the value of 293.15; p_{sc} represents the pressure under the standard condition, MPa, with the value of 0.101325; pᵢ represents the initial coal reservoir pressure, MPa; T represents the coal reservoir temperature, K; Zᵢ represents the conventional gas deviation factor under the initial coal reservoir pressure, dimensionless; and Cₛ represents the solubility coefficient of the coalbed methane in the water, MPa⁻¹.

Step S720, the iterative value of the control volume is returned to replace the initially given value of the control volume for the loop calculation, and the loop calculation is stopped when the difference between the values of the control volume from two adjacent iterations of the loop calculation is less than the preset value.

Specifically, the preset value is 10⁻⁶ 10⁶ m³. When the difference between the values of the control volume from two adjacent iterations of the loop calculation is less than 10⁻⁶ 10⁶ m³, the loop calculation is stopped, and the control volume, the original gas in place of the reservoir, and the prediction model for the gas production of the reservoir are finally determined. A final linear trend expression of the prediction model for the gas production of the reservoir can be a ninth calculation formula. The ninth calculation formula is expressed as follows:

$$\frac{p}{{Z}^{*}} = N - M \cdot {G}_{p} .$$

More specifically, M and N in the ninth calculation formula can be obtained in a last iteration of the loop calculation. The linear trend line in the Cartesian coordinate system with p/Z* as the vertical axis and the Gₚ as the horizontal axis is extended to intersect with the horizontal axis, generating an intersection point. A value corresponding to the intersection point is the original gas in place Gᵢ of the reservoir of the deep coalbed methane.

Step S800, a first relationship model between the cumulative water production and the average coal reservoir pressure is determined, and a predicted value on the vertical axis of the prediction model under a given abandonment pressure is determined based on the first relationship model.

Further, the prediction model for the gas production of the reservoir is a relationship between p/Z* and Gₚ. Moreover, it can be known from the sixth calculation formula that the actual average gas deviation factor Z* is related to the cumulative water production Wₚ. By establishing the first relationship model between the cumulative water production Wₚ and the average coal reservoir pressure p, and under a condition of taking the given abandonment pressure as the average coal reservoir pressure, the predicted value p/Z* on the vertical axis can be obtained based on the first relationship model and the sixth calculation formula.

In an embodiment, the step S800 of determining the first relationship model between the cumulative water production and the average coal reservoir pressure and determining the predicted value on the vertical axis of the prediction model under a given abandonment pressure based on the first relationship model includes step S810 through step S820.

Step S810, the cumulative water production and the average coal reservoir pressure corresponding to a last production date of the multiple production dates, and the iterative value of the control volume, the corrected value of reservoir porosity, and the corrected value of water saturation obtained in the last iteration of the loop calculation are substituted into a tenth calculation formula to obtain the first relationship model, in which the tenth calculation formula is expressed as follows:

$${W}_{p} = {W}_{p s} + \frac{( V {ϕ}_{i p} {S}_{w i p} {R}_{w} - {W}_{p s} ) \cdot ( {p}_{s} - p )}{( 2.5 + {p}_{s} - p )} ;$$

where, Wₚ represents the cumulative water production, 10⁶ m³; p represents the average coal reservoir pressure, MPa; Wₚₛ represents the cumulative water production corresponding to the last production date of the multiple production dates, 10⁶ m³; pₛ represents the average coal reservoir pressure corresponding to the last production date of the multiple production dates, MPa; V represents the iterative value of the control volume obtained in the last iteration of the loop calculation, 10⁶ m³; φᵢₚ represents the corrected value of reservoir porosity obtained in the last iteration of the loop calculation, decimal; S_{wip} represents the corrected value of water saturation obtained in the last iteration of the loop calculation, decimal; and R_{w} represents a recovery factor of water, with a value of 35%.

Step S820, the predicted value on the vertical axis of the prediction model under the given abandonment pressure is determined based on the first relationship model.

In a first embodiment, the step S820 of determining the predicted value on the vertical axis of the prediction model under the given abandonment pressure based on the first relationship model includes the following step S8210-1 through step S8230-1.

Step S8210-1, the given abandonment pressure is substituted as the average coal reservoir pressure into the first relationship model to calculate a cumulative water production under the given abandonment pressure.

Step S8220-1, the given abandonment pressure as the average coal reservoir pressure and the cumulative water production under the given abandonment pressure are substituted into the sixth calculation formula to obtain an actual average gas deviation factor under the given abandonment pressure.

Step S8230-1, a ratio of the given abandonment pressure to the actual average gas deviation factor under the given abandonment pressure is determined as the predicted value on the vertical axis of the prediction model under the given abandonment pressure.

It should be understood that, in the first embodiment, the predicted value on the vertical axis of the prediction model under the given abandonment pressure is obtained by formula calculation.

In a second embodiment, the step S820 of determining the predicted value on the vertical axis of the prediction model under the given abandonment pressure based on the first relationship model includes the following step S8210-2 through step S8240-2.

Step S8210-2, a given pressure value lower than the average coal reservoir pressure corresponding to the last production date of the multiple production dates as an average coal reservoir pressure is substituted into the first relationship model to calculate a cumulative water production at the given pressure value.

Step S8220-2, the given pressure value and the cumulative water production at the given pressure value are substituted into the sixth calculation formula to obtain an actual average gas deviation factor at the given pressure value.

Step S8230-2, a second relationship model is established using the given pressure value, serving as the average coal reservoir pressure, as a horizontal axis and a ratio of the given pressure value to the actual average gas deviation factor at the given pressure value as a vertical axis.

Step S8240-2, the given abandonment pressure as the average coal reservoir pressure is substituted into the second relationship model to obtain the predicted value on the vertical axis of the prediction model under the given abandonment pressure.

It should be understood that, in the second embodiment, the second relationship model between the p/Z* and p is firstly established through the first relationship model and the sixth calculation formula. The given abandonment pressure is then used as a horizontal axis value to query a corresponding vertical axis value in the second relationship model, and the corresponding vertical axis value is determined as the prediction value on the vertical axis of the prediction model under the given abandonment pressure.

Step S900, the predicted value on the vertical axis is substituted into a prediction model established in the last iteration of the loop calculation to obtain a recoverable reserve of the coalbed methane, and the recovery factor is calculated.

In an embodiment, the step S900 of substituting the predicted value on the vertical axis into the prediction model established in the last iteration of the loop calculation to obtain the recoverable reserve of the coalbed methane and calculating the recovery factor includes step S910 and step S920.

Step S910, the predicted value on the vertical axis is substituted into the prediction model established in the last iteration of the loop calculation to obtain the recoverable reserve of the coalbed methane, in which an eleventh calculation formula for the recoverable reserve of the coalbed methane is expressed as follows:

$${G}_{pab} = \frac{N - \frac{{p}_{ab}}{{Z}_{ab}^{*}}}{M} ,$$

where G_{pab} represents the recoverable reserve of the coalbed methane, 10⁶ m³; P_{ab} represents the given abandonment pressure, MPa; and

$${Z}_{a b}^{*}$$

represents the actual average gas deviation factor under the given abandonment pressure.

Step S920, the recoverable reserve and an original gas in place of the reservoir obtained in the last iteration of the loop calculation are substituted into a twelfth calculation formula to calculate the recovery factor of the coalbed methane, in which the twelfth calculation formula is expressed as follows:

$${R}_{cbm} = \frac{{G}_{pad}}{{G}_{i}} ;$$

where R_{cbm} represents the recovery factor of the deep coalbed methane, G_{pab} represents the recoverable reserve of the deep coalbed methane, 10⁶ m³; and Gᵢ represents the original gas in place of the reservoir, 10⁶ m³.

The disclosure proposed the method for predicting final recoverable reserve and the recovery factor of the deep coalbed methane based on the principle of material balance of deep coalbed methane reservoirs and considering the pressure difference between the adsorbed gas pores and the free gas pores and the impact of the fracturing modification on the changes in the physical parameters of the coal reservoir and the dissolved gas. The prediction method, under conditions of known physical parameters of the reservoir, physical parameters of the fluid, and fracturing fluid injection-flowback data, only requires at least two sets of measured average coal reservoir pressure and corresponding cumulative gas production and cumulative water production data to predict the final recoverable reserve and the recovery factor of the deep coalbed methane, which is simple and straightforward, making it convenient for popularization and application.

### Embodiment 1

A multi-stage fractured horizontal well P1 in a certain deep coalbed methane reservoir has known physical parameters of a reservoir, physical parameters of fluid, and fracturing fluid injection-flowback data. During a production period, the multi-stage fractured horizontal well P1 is measured four times to obtain the average coal reservoir pressure. Recovery factors of coalbed methane under given abandonment pressures of 4 MPa, 3 MPa, and 2 MPa are predicted, respectively.
1. The physical parameters of the reservoir and the physical parameters of the fluid are organized and statistically analyzed.

TABLE 1
Statistical table of the physical parameters of the
reservoir and the physical parameters of the fluid

| Parameters | Value | Unit |
|---|---|---|
| Density of coal rock ρ_{c} | 1.5 | t/m³ |
| Initial porosity of coal reservoir φᵢ | 0.07 | decimal |
| Initial coal reservoir pressure pᵢ | 21 | MPa |
| Coal reservoir temperature T | 343.15 | K |
| Initial water saturation of | 0.60433 | decimal |
| coal reservoir S_{wi} | | |
| Pore compressibility Cₚ | 0.005 | MPa⁻¹ |
| Average pore diameter of micropores | 2 | nm |
| in coal matrix d | | |
| Average pore diameter of mesopores | 10 | nm |
| in coal matrix D | | |
| Wetting angle of surface | 89 | ° |
| of coal matrix θ | | |
| Coal matrix shrinkage coefficient Cₐ | 0.1 | dimensionless |
| Langmuir volume V_{L} | 25 | m³/t |
| Langmuir pressure p_{L} | 3.21 | MPa |
| Specific gravity of natural gas γ_{g} | 0.6 | dimensionless |
| Gas deviation factor under initial | 0.8895 | dimensionless |
| coal reservoir pressure Zᵢ | | |
| Volume coefficient of water B_{w} | 1 | m³/m³ |
| Isothermal compressibility of water C_{w} | 0.000435 | MPa⁻¹ |
| Solubility coefficient of coalbed | 0.17 | MPa⁻¹ |
| methane in water Cₛ | | |
| Interfacial tension between | 60 | mN/m |
| gas and water σ_{gw} | | |

2. The average coal reservoir pressure, the cumulative gas production, and the cumulative water production at the multiple production dates are organized and statistically analyzed. The conventional average gas deviation factor at the multiple production dates is calculated.

TABLE 2
Statistical table of the average coal reservoir pressure, the cumulative
gas production, the cumulative water production, and the conventional
average gas deviation factor at the multiple production dates

| | | | | | Cumulative |
|---|---|---|---|---|---|
| | | | | Cumulative | water influx |
| | Average coal | Conventional | Cumulative | water | during |
| | reservoir | average gas | gas | production | production |
| Production | pressure | deviation factor | production | Wₚ/ | process Wₑ/ |
| day/day(d) | p/MPa | Z/dimensionless | Gₚ/10⁶ m³ | 10⁶ m³ | 10⁶ m³ |
| 113 | 16.46 | 0.87968 | 7.813145 | 0.00608 | 0 |
| 252 | 13.53 | 0.88362 | 14.411287 | 0.007407 | 0 |
| 481 | 11.3 | 0.89242 | 20.404332 | 0.008452 | 0 |
| 1075 | 9.5 | 0.90309 | 25.204769 | 0.014221 | 0 |

3. The capillary pressure between the micropores and the mesopores in the coal reservoir is calculated.

The average pore diameter of the micropores in the coal matrix d=2 nm, the average pore diameter of the mesopores in the coal matrix D=10 nm, the interfacial tension between gas and water σ_{gw}=60 mN/m, and the wetting angle of the surface of the coal matrix θ=890 are substituted into the first calculation formula to obtain the capillary pressure between the micropores and the mesopores in the coal reservoir p_{c}=0.8377 MPa:

$$\begin{matrix}{p}_{c} = 2 ( \frac{1}{d} - \frac{1}{D} ) {σ}_{g w} cos θ \\ = 2 ( \frac{1}{2} - \frac{1}{10} ) \times 60 \times cos ( 89 ° ) \\ = 0.8377 ( MPa ) .\end{matrix}$$

The initial coal reservoir pressure pᵢ=21 MPa and the capillary pressure between the micropores and the mesopores in the coal reservoir p_{c}=0.8377 MPa are substituted into the second calculation formula to calculate the initial pressure of the adsorbed gas in adsorption pores of the coal reservoir pₘᵢ=21.8377 MPa:

$${p}_{m i} = {p}_{i} + {p}_{c} = 21 + 0.8377 = 21.8377 ( MPa ) .$$

4. The total fracturing fluid volume and the cumulative flowback volume of the deep coalbed methane well are statistically analyzed, and the net fracturing injection volume is calculated.

The total fracturing fluid volume W_{fi}=0.03 (10⁶ m³) during the fracturing process and the cumulative flowback volume W_{fp}=0.0075 (10⁶ m³) during the flowback process of the deep coalbed methane well are statistically analyzed. The net fracturing injection volume W_{fin}=0.0225 (10⁶ m³) is calculated using the third calculation formula:

$${W}_{f i n} = {W}_{f i} - {W}_{f p} = 0.03 - 0.0075 = 0.0 \; 225 ( {10}^{6} {m}^{3} ) .$$

Results are recorded in Table 3.

TABLE 3
Statistical table of fracturing and flowback
data of the deep coalbed methane well

| Parameter | Value | Unit |
|---|---|---|
| Total fracturing fluid volume W_{fi} | 0.03 | 10⁶ m³ |
| Cumulative flowback volume W_{fp} | 0.0075 | 10⁶ m³ |
| Net fracturing injection volume W_{fin} | 0.0225 | 10⁶ m³ |

5. The corrected value of reservoir porosity and the corrected value of water saturation after fracturing flowback but before production are calculated.

The initially given value of the control volume V of the deep coalbed methane well is determined based on the geological knowledge. A length of a horizontal section of the deep coalbed methane well is 1000 m, the distance among horizontal wells is 350 m, and the thickness of the deep coal reservoir is 10 m; based on this, the initially given value of the control volume V of the deep coalbed methane well is 3.5 (10⁶ m³). The initially given value of the control volume V, the initial porosity of the coal reservoir φᵢ=0.07, the net fracturing injection volume W_{fin}=0.0225 (10⁶ m³), and the volume coefficient of water B_{w}=1 are substituted into the fourth calculation formula to calculate an initial value of the reservoir porosity after fracturing flowback but before production φᵢₚ=0.076429

$${ϕ}_{i p} = {ϕ}_{i} + \frac{{W}_{f i n} {B}_{w}}{V} = 0.07 + \frac{0.0225 \times 1}{3.5} = 0.076429 .$$

The initially given value of the control volume V of the deep coalbed methane well of 3.5 (10⁶ m³), the initial porosity of the coal reservoir φᵢ=0.07, the initial water saturation of the coal reservoir S_{wi}=0.60433, the net fracturing injection volume W_{fin}=0.0225 (10⁶ m³), the volume coefficient of water B_{w}=1, and the calculated initial value of reservoir porosity after fracturing flowback but before production φᵢₚ=0.076429 are substituted into the fifth calculation formula to calculate an initial value of water saturation after fracturing flowback but before production S_{wip}=0.63761:

$${S}_{w i p} = \frac{{ϕ}_{i} {S}_{w i} + \frac{{W}_{f i n} {B}_{W}}{V}}{{ϕ}_{i p}} = \frac{0.07 \times 0.604329 + \frac{0.0225 \times 1}{3.5}}{0.076429} = 0.63761 .$$

6. The actual average gas deviation factor Z* and the ratio p/Z* of the average coal reservoir pressure to the actual average gas deviation factor at the multiple production dates are calculated.

The actual average gas deviation factor Z* and the ratio p/Z* of the average coal reservoir pressure to the actual average gas deviation factor at the multiple production dates are calculated using the sixth calculation formula, and calculation results are recorded in Table 4.

TABLE 4
Statistical table of dynamic data for reservoir production

| | | | | | Cumulative | | |
|---|---|---|---|---|---|---|---|
| | Measured | | | | water influx | | |
| | average | Conventional | Cumulative | Cumulative | during | | |
| | coal | average gas | gas | water | production | | |
| | reservoir | deviation | production | production | process | | |
| | pressure | factor Z/ | Gₚ/ | Wₚ/ | Wₑ/ | Z*/ | (p/Z*)/ |
| Date | p/MPa | dimensionless | 10⁶ m³ | 10⁶ m³ | 10⁶ m³ | dimensionless | MPa |
| 113 | 16.46 | 0.87968 | 7.813145 | 0.00608 | 0 | 0.293398 | 56.1013 |
| 252 | 13.53 | 0.88362 | 14.411287 | 0.007407 | 0 | 0.254384 | 53.18723 |
| 481 | 11.3 | 0.89242 | 20.404332 | 0.008452 | 0 | 0.223297 | 50.60529 |
| 1075 | 9.5 | 0.90309 | 25.204769 | 0.014221 | 0 | 0.196418 | 48.36625 |

7. The prediction model for gas production of the reservoir is established, and the original gas in place of the reservoir is determined.

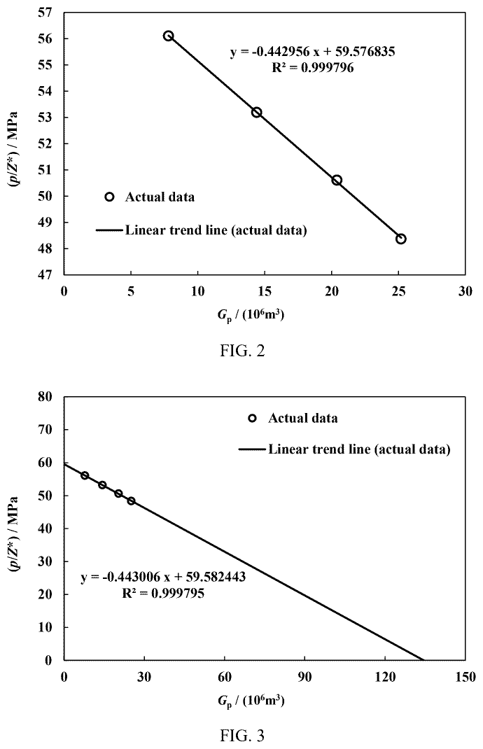

The scatter plot is drawn in the Cartesian coordinate system by using Gₚ as the horizontal axis and p/Z* as the vertical axis, as illustrated in FIG. 2. By using linear fitting, the slope value −M of the linear trend line obtained is −0.442956, and the Y-axis intercept value N of the linear trend line is 59.576835.

The original gas in place of the reservoir is calculated according to the seventh calculation formula to be 134.49831 (10⁶ m³)

$${G}_{i} = \frac{N}{M} = \frac{59.576835}{0.442956} = 134.4 \; 9831 ( {10}^{6} {m}^{3} ) .$$

8. The iterative value of the control volume is calculated and the loop calculation is performed.

The iterative value of the control volume V is calculated using the eighth calculation formula to be 3.5042742 (10⁶ m³):

$$\begin{matrix}V = \frac{{G}_{i}}{[ {ρ}_{c} \frac{{V}_{L} ( {p}_{i} + {p}_{c} )}{{p}_{L} + {p}_{i} + {p}_{C}} + \frac{{ϕ}_{ip} ( 1 - {s}_{w {i}_{P}} ) {Z}_{sc} {T}_{sc} {p}_{i}}{{p}_{sc} {Z}_{i} T} + {ϕ}_{i p} {S}_{w i p} {C}_{s} {p}_{i} ]} \\ = \frac{134. 49831}{\begin{matrix}[ 1.5 \times \frac{25 \times ( 21 + 08377 )}{3.21 + 21 + 0.8377} + \\ \frac{0.076429 \times ( 1 - 0.63761 ) \times 1 \times 2 \; 93 , 15 \times 21}{0.101325 \times 0.8895 \times 34315} + \\ 0.076429 \times 0. 63761 \times 0.17 \times 21 ]\end{matrix}} \\ = 3.5 4 \; 2742 ( {10}^{6} {m}^{3} )\end{matrix} .$$

The iterative value 3.5042742 (10⁶ m³) of the control volume V is returned to replace the initially given value 3.5 (10⁶ m³) of the control volume V for looping steps 5-8. When the difference between the values of the control volume V from two adjacent iterations of the loop calculation is less than 10⁻⁶ (10⁶ m³), the loop calculation is stopped. The final value of the control volume V is finally determined to be 3.5042111 (10⁶ m³). The reservoir porosity after fracturing flowback but before production φᵢₚ is 0.076421, the water saturation after fracturing flowback but before production S_{wip} is 0.63757, the slope value −M of the linear trend line obtained is −0.443006, the Y-axis intercept value N of the linear trend line is 59.582443, and the original gas in place of the reservoir Gᵢ controlled by the deep coalbed methane well P1 is 134.49579 (10⁶ m³):

$${G}_{i} = \frac{N}{M} = \frac{59.582443}{0.443006} = 134.4 \; 9579 ( {10}^{6} {m}^{3} ) .$$

A final linear trend expression of the prediction model or the gas production of the reservoir is:

$$\frac{p}{{Z}^{*}} = 59. 582443 - 0.4 \; 43006 \cdot {G}_{p} .$$

The linear trend line in the Cartesian coordinate system with p/Z* as the vertical axis and the Gₚ as the horizontal axis is extended to intersect with the horizontal axis, generating the intersection point, and the value corresponding to the intersection point is the original gas in place Gᵢ of the reservoir controlled by the deep coalbed methane well, as illustrated in FIG. 3.
9. The first relationship model between Wₚ and p is determined, and the second relationship model between p/Z* and p is determined.

It can be seen from Table 2 that a last measured average coal reservoir pressure pₛ of the deep coalbed methane well is 9.5 (MPa), and a cumulative water production Wₚₛ under the last measured average coal reservoir pressure of the deep coalbed methane well is 0.014221 (10⁶ m³).

The final value of the control volume V for the deep coalbed methane well P1 of 3.5042111, a value of reservoir porosity after fracturing flowback but before production φᵢₚ of 0.076421, a value of water saturation after fracturing flowback but before production S_{wip} of 0.63757, the recovery factor of water R_{w} of 35%, the last measured average coal reservoir pressure pₛ of the deep coalbed methane well of 9.5, and the cumulative water production Wₚₛ under the last measured average coal reservoir pressure of 0.014221 are substituted into the tenth calculation formula to obtain a relationship expression between Wₚ and p as follows:

$$\begin{matrix}{W}_{p} = {W}_{p s} + \frac{( V {ϕ}_{i p} {S}_{w i p} {R}_{w} - {W}_{p s} ) \cdot ( {p}_{s} - p )}{( 2.5 + {p}_{s} - p )} \\ = 0.01 42 \; 21 + \frac{\begin{matrix}( 3.5 042111 \times 0.076421 \times 0.637 \; 57 \times \\ 35 \% - 0.014221 ) \times ( 9.5 - p )\end{matrix}}{( 2.5 + 9.5 - p )} \\ = 0.01 4221 + 0.45538 \times \frac{9.5 - p}{12 - p}\end{matrix} .$$

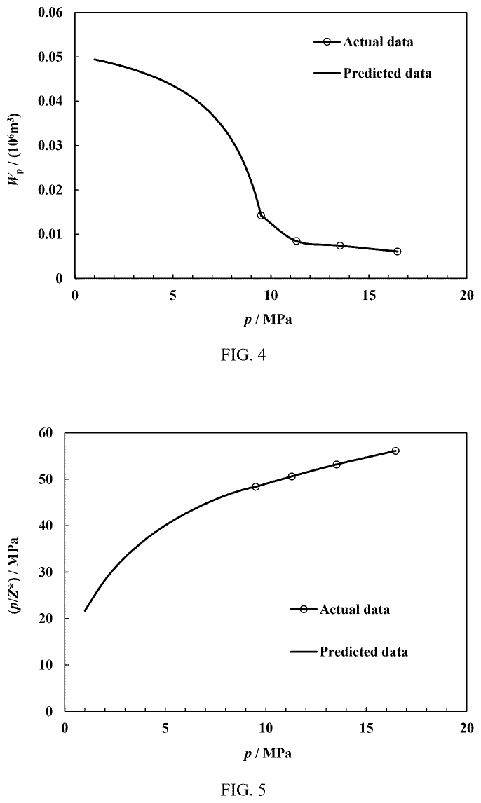

A pressure p lower than the last measured average coal reservoir pressure is given, and Wₚ is calculated using the tenth calculation formula, as illustrated in FIG. 4, to obtain the first relationship model between the cumulative water production Wₚ and the average coal reservoir pressure p. The pressure p and a calculated Wₚ are substituted into the sixth calculation formula to calculate Z* under the pressure p, and p/Z* under the pressure p is calculated.

Taking the pressure p=7 MPa, Wₚ is calculated using the tenth calculation formula to be 0.03699 (10⁶ m³):

$${W}_{p} = 0.014221 + 0.45538 \times \frac{9.5 - p}{12 - p} = 0.014221 + 0.45538 \times \frac{9.5 - 7}{12 - 7} = 0.03699 ( {10}^{6} {m}^{3} ) .$$

The pressure p=7 MPa and Wₚ=0.03699 (10⁶ m³) are substituted into the sixth calculation formula to calculate Z* under the pressure p=7 MPa is 0.156526, and p/Z* under the pressure p=7 MPa is calculated to be 44.72088.

The second relationship model between p/Z* and p is drawn in the Cartesian coordinate system using p as a horizontal axis and p/Z* as a vertical axis, as illustrated in FIG. 5.
10. The recovery factor of the coalbed methane under the given abandonment pressure p_{ab} is predicted.

When p_{ab} is 4 MPa, 3 MPa, and 2 MPa respectively, according to the second relationship model between p/Z* and p of the deep coalbed methane well P1,

$${p}_{a b} / {Z}_{a b}^{*}$$

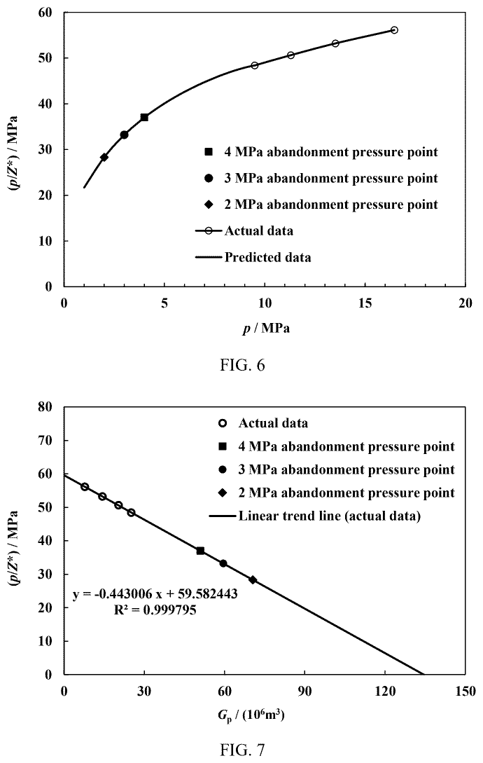

corresponding to p_{ab} of 4 MPa, 3 MPa, and 2 MPa are found to be 36.996426 (MPa), 33.201957 (MPa), and 28.317827 (MPa), as illustrated in FIG. 6.

Alternatively, the given abandonment pressure p_{ab} of 4 MPa, 3 MPa, and 2 MPa is respectively substituted into the tenth calculation formula to calculate the W_{pab} to be 0.045528 (10⁶ m³), 0.047109 (10⁶ m³), and 0.048374 (10⁶ m³), correspondingly. pab being 4 MPa, 3 MPa, and 2 MPa and W_{pab} being 0.045528 (10⁶ m³), 0.047109 (10⁶ m³) and 0.048374 (10⁶ m³) are substituted into the sixth calculation formula respectively to calculate

$${Z}_{a b}^{*}$$

under P_{ab} being 4 MPa, 3 MPa, and 2 MPa to be 0.108119, 0.090356, and 0.070627, correspondingly. Subsequently,

$${p}_{a b} / {Z}_{a b}^{*}$$

under p_{ab} being 4 MPa, 3 MPa, and 2 MPa is calculated to be 36.996426 (MPa), 33.201957 (MPa), and 28.317827 (MPa).

On an extended line of the linear trend line for the prediction model of

$${p}_{a b} / {Z}_{a b}^{*}$$

### and Gₚ,

$${p}_{a b} / {Z}_{a b}^{*}$$

being 36.996426 (MPa), 33.201957 (MPa), and 28.317827 (MPa) are found, and Gₚ corresponding to

$${p}_{a b} / {Z}_{a b}^{*}$$

are 50.983547 (10⁶ m³), 59.548823 (10⁶ m³), and 70.573798 (10⁶ m³), respectively. That is, the final recoverable reserve G_{pab} of the coalbed methane under the given abandonment pressure pab being 4 MPa, 3 MPa, and 2 MPa are 50.983547 (10⁶ m³), 59.548823 (10⁶ m³), and 70.573798 (10⁶ m³), respectively, as illustrated in FIG. 7.

Alternatively,

$${p}_{a b} / {Z}_{a b}^{*}$$

is substituted into the eleventh calculation formula to calculate the final recoverable reserve G_{pab} of the coalbed methane under the given abandonment pressure p_{ab}.

Taking the given abandonment pressure p_{ab} being 3 MPa as an example,

$${p}_{a b} / {Z}_{a b}^{*}$$

being 33.201957 (MPa) is substituted into the eleventh calculation formula to calculate the final recoverable reserve G_{pab} of the coalbed methane under the given abandonment pressure p_{ab} of 3 MPa to be 59.548823 (10⁶ m³):

$${G}_{p a b} = \frac{N - \frac{{p}_{a b}}{{Z}_{a b}^{*}}}{M} = \frac{59.582443 - 33.201957}{0.443006} = 59.54 \; 8823 ( {10}^{6} {m}^{3} ) .$$

The recovery factor of the coalbed methane under the given abandonment pressure P_{ab} of 4 MPa, 3 MPa, and 2 MPa is 37.91%, 44.28%, and 52.47%, respectively.

Taking the given abandonment pressure p_{ab} being 3 MPa as an example, the final recoverable reserve G_{pab} of the coalbed methane under the given abandonment pressure P_{ab} of 3 MPa being 59.548823 (10⁶ m³) and the original gas in place of the reservoir Gᵢ controlled by the deep coalbed methane well P1 being 134.49579 (10⁶ m³) are substituted into the twelfth calculation formula to calculate the recovery factor of the coalbed methane under the given abandonment pressure p_{ab} of 3 MPa to be 44.28%:

$${R}_{c b m} = \frac{{G}_{p a b}}{{G}_{i}} = \frac{59.548823}{134.49579} = 44.28 \% .$$

In addition, a processor is provided in another embodiment of the disclosure, and the processor is configured to implement the method for predicting the recovery factor of the deep coalbed methane as described above.

In addition, a machine-readable storage medium is provided in further another embodiment of the disclosure. The machine-readable storage medium is stored with instructions. The instructions, when executed by a processor, are configured to implement the method for predicting the recovery factor of the deep coalbed methane as described above.

Those skilled in the art should understand that the embodiments of the disclosure may be provided as methods, systems, or computer program products. Accordingly, the disclosure may take a form of entirely hardware embodiments, entirely software embodiments, or embodiments combining both software and hardware aspects. Furthermore, the disclosure may take the form of a computer program product implemented on one or more computer-usable storage media (including but not limited to disk memory, compact disc read-only memory (CD-ROM), optical memory, etc.) containing computer-usable program code.

This disclosure is described with reference to flowcharts and/or block diagrams of methods, devices (systems), and computer program products according to the embodiments of the disclosure. It should be understood that each process and/or block of the flowchart and/or block diagram and combinations of processes and/or blocks in the flowchart and/or block diagram can be implemented by computer program instructions. These computer program instructions may be provided to a processor of a general-purpose computer, special-purpose computer, embedded processor, or other programmable data processing device to produce a machine, such that instructions executed via the processor of the computer or other programmable data processing device create means for implementing functions specified in one process or multiple processes of the flowchart and/or one block or multiple blocks of the block diagram.

These computer program instructions may also be stored in a computer-readable storage medium that can direct a computer or other programmable data processing device to operate in a particular manner, such that instructions stored in the computer-readable storage medium produce an article of manufacture including instruction means which implement the functions specified in one process or multiple processes of the flowchart and/or one block or multiple blocks of the block diagram.

These computer program instructions may also be loaded onto a computer or other programmable data processing device, such that a series of operations are performed on the computer or other programmable device to produce a computer-implemented process, thereby providing steps for carrying out the functions specified in one process or multiple processes of the flowchart and/or one block or multiple blocks of the block diagram when executed on the computer or other programmable device.

In a typical configuration, the computing device includes one or more processors (central processing unit, CPU), input/output interfaces, network interfaces, and memory.

The memory may include forms such as non-persistent storage in computer-readable media, random access memory (RAM), and/or non-volatile memory, such as read-only memory (ROM) or flash RAM. The memory is an example of a computer-readable medium.

It should also be noted that terms “including”, “comprising”, or any other variations thereof are intended to cover non-exclusive inclusion, thereby enabling processes, methods, products, or devices that include a series of elements to not only encompass those elements but also any other elements not explicitly listed, or elements inherently associated with such processes, methods, products, or devices. Unless otherwise specified, an element defined by a phrase “including a . . . ” does not preclude existence of additional identical elements in the processes, methods, products, or devices that includes the element.

The above-described contents are merely embodiments of the disclosure and are not intended to limit the disclosure. For those skilled in the art, various modifications and changes can be made to the disclosure. Any modifications, equivalent replacements, improvements, etc., made within a spirit and principles of the disclosure shall fall within a scope of the claims of the disclosure.

1. A method for predicting a recovery factor of deep coalbed methane, comprising the following steps:
determining physical parameters of a reservoir and fluid, respectively;
determining an average coal reservoir pressure, a cumulative gas production, and a cumulative water production at a plurality of production dates, and determining a conventional average gas deviation factor based on the average coal reservoir pressure;
determining a capillary pressure between micropores and mesopores in the reservoir;
determining, based on an initially given value of a control volume, a corrected value of reservoir porosity and a corrected value of water saturation after fracturing flowback but before production;
calculating an actual average gas deviation factor based on the physical parameters, the capillary pressure, the initially given value of the control volume, the corrected value of reservoir porosity, the corrected value of water saturation, and the average coal reservoir pressure, the cumulative water production, and the conventional average gas deviation factor at the plurality of production dates;
establishing a prediction model for gas production of the reservoir using the cumulative gas production as a horizontal axis and a ratio of the average coal reservoir pressure to the actual average gas deviation factor as a vertical axis, and determining an original gas in place of the reservoir based on the prediction model for the gas production of the reservoir;
calculating an iterative value of the control volume based on the physical parameters, the capillary pressure, the corrected value of reservoir porosity, the corrected value of water saturation, and the original gas in place of the reservoir; returning the iterative value of the control volume to replace the initially given value of the control volume for loop calculation; and stopping the loop calculation when a difference between values of the control volume from two adjacent iterations of the loop calculation is less than a preset value;
determining a first relationship model between the cumulative water production and the average coal reservoir pressure, and determining, based on the first relationship model, a predicted value on the vertical axis of the prediction model under a given abandonment pressure; and
substituting the predicted value on the vertical axis into a prediction model established in a last iteration of the loop calculation to obtain a recoverable reserve of coalbed methane, and calculating the recovery factor;
wherein the calculating an actual average gas deviation factor based on the physical parameters, the capillary pressure, the initially given value of the control volume, the corrected value of reservoir porosity, the corrected value of water saturation, and the average coal reservoir pressure, the cumulative water production, and the conventional average gas deviation factor at the plurality of production dates comprises:
substituting the physical parameters, the capillary pressure, the initially given value of the control volume, the corrected value of reservoir porosity, the corrected value of water saturation, the average coal reservoir pressure, the cumulative water production, and the conventional average gas deviation factor into a sixth calculation formula to calculate the actual average gas deviation factor at the plurality of production dates; wherein the sixth calculation formula is expressed as follows:
$${Z}^{*} = {( \begin{matrix}\frac{{p}_{s c} T {ρ}_{c} {V}_{L} ( p + {p}_{c} )}{( {p}_{i p} {Z}_{s c} {T}_{s c} p ( {p}_{L} + p + {p}_{c} )} + \\ \frac{{p}_{s c} T {C}_{s} ( {S}_{w i p} + {S}_{w i p} {C}_{w} ( {p}_{i} - p ) + \frac{{W}_{e} - {W}_{p} {B}_{w}}{V {ϕ}_{i p}} )}{{Z}_{s c} {T}_{s c}} + \\ \frac{\begin{matrix}1 - {S}_{w i p} - ( {C}_{p} + {s}_{w i p} {c}_{w} ) ( {p}_{i} - p ) + {C}_{a} ( \frac{{p}_{i} + {p}_{c}}{{p}_{L} + {p}_{i} + {p}_{c}} - \\ \frac{p + {p}_{c}}{{p}_{L} + p + {p}_{c}} ) - \frac{{W}_{e} - {W}_{p} {B}_{w}}{V {ϕ}_{i p}}\end{matrix}}{Z}\end{matrix} )}^{- 1}$$
where Z* represents the actual average gas deviation factor, dimensionless; ρ_{c} represents a density of coal rock, tons per cubic meter (t/m³); V_{L} represents a Langmuir volume, cubic meters per ton (m³/t); p_{L} represents a Langmuir pressure, megapascal (MPa); p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc} represents a conventional gas deviation factor under a standard condition, dimensionless, with a value of 1; T_{sc} represents a temperature under the standard condition, Kelvin (K), with a value of 293.15; pᵢ represents an initial coal reservoir pressure, MPa; p_{sc} represents a pressure under the standard condition, MPa, with a value of 0.101325; T represents a coal reservoir temperature, K; p represents the average coal reservoir pressure, MPa; Z represents the conventional average gas deviation factor, dimensionless; Cₚ represents a pore compressibility, per megapascal (MPa⁻¹); C_{w} represents an isothermal compressibility of water, MPa⁻¹; Cₛ represents a solubility coefficient of the coalbed methane in water, MPa⁻¹; Cₐ represents a coal matrix shrinkage coefficient, dimensionless; Wₑ represents a cumulative water influx, 10⁶ cubic meter (m³), with a value of 0; Wₚ represents the cumulative water production, 10⁶ m³; B_{w} represents a volume coefficient of the water, cubic meter per cubic meter (m³/m³), with a value of 1; and V represents the initially given value of the control volume, 10⁶ m³;
wherein the determining a first relationship model between the cumulative water production and the average coal reservoir pressure, and determining, based on the first relationship model, a predicted value on the vertical axis of the prediction model under a given abandonment pressure comprises:
substituting the cumulative water production and the average coal reservoir pressure corresponding to a last production date of the plurality of production dates, and the iterative value of the control volume, the corrected value of reservoir porosity, and the corrected value of water saturation obtained in the last iteration of the loop calculation into a tenth calculation formula to obtain the first relationship model; wherein the tenth calculation formula is expressed as follows:
$${W}_{p} = {W}_{p s} + \frac{( V {ϕ}_{i p} {S}_{w i p} {R}_{w} - {W}_{p s} ) \cdot ( {p}_{s} - p )}{( 2.5 + {p}_{s} - p )} ;$$
where, Wₚ represents the cumulative water production, 10⁶ m³; p represents the average coal reservoir pressure, MPa; Wₚₛ represents the cumulative water production corresponding to the last production date of the plurality of production dates, 10⁶ m³; pₛ represents the average coal reservoir pressure corresponding to the last production date of the plurality of production dates, MPa; V represents the iterative value of the control volume obtained in the last iteration of the loop calculation, 10⁶ m³; φᵢₚ represents the corrected value of reservoir porosity obtained in the last iteration of the loop calculation, decimal; S_{wip} represents the corrected value of water saturation obtained in the last iteration of the loop calculation, decimal; and R_{w} represents a recovery factor of water, with a value of 35%; and
determining, based on the first relationship model, the predicted value on the vertical axis of the prediction model under the given abandonment pressure.

2. The method for predicting the recovery factor of the deep coalbed methane as claimed in claim 1, wherein the determining, based on the first relationship model, the predicted value on the vertical axis of the prediction model under the given abandonment pressure comprises:
substituting the given abandonment pressure as the average coal reservoir pressure into the first relationship model to calculate a cumulative water production under the given abandonment pressure;
substituting the given abandonment pressure as the average coal reservoir pressure and the cumulative water production under the given abandonment pressure into the sixth calculation formula to obtain an actual average gas deviation factor under the given abandonment pressure; and
determining a ratio of the given abandonment pressure to the actual average gas deviation factor under the given abandonment pressure as the predicted value on the vertical axis of the prediction model under the given abandonment pressure.

3. The method for predicting the recovery factor of the deep coalbed methane as claimed in claim 1, wherein the determining, based on the first relationship model, the predicted value on the vertical axis of the prediction model under the given abandonment pressure comprises:
substituting a given pressure value lower than the average coal reservoir pressure corresponding to the last production date of the plurality of the production dates as the average coal reservoir pressure into the first relationship model to calculate a cumulative water production at the given pressure value;
substituting the given pressure value and the cumulative water production at the given pressure value into the sixth calculation formula to obtain an actual average gas deviation factor at the given pressure value;
establishing a second relationship model using the given pressure value serving as the average coal reservoir pressure as a horizontal axis and a ratio of the given pressure value to the actual average gas deviation factor at the given pressure value as a vertical axis; and
substituting the given abandonment pressure as the average coal reservoir pressure into the second relationship model to obtain the predicted value on the vertical axis of the prediction model under the given abandonment pressure.

4. The method for predicting the recovery factor of the deep coalbed methane as claimed in any one of claims 1-3, wherein the determining a capillary pressure between micropores and mesopores in the reservoir comprises:
determining, based on a first calculation formula, the capillary pressure between the micropores and the mesopores in the reservoir; wherein the first calculation formula is expressed as follows:
$${p}_{c} = 2 ( \frac{1}{d} - \frac{1}{D} ) {σ}_{g w} cos θ ;$$
where, p_{c} represents the capillary pressure between the micropores and the mesopores in the reservoir, MPa; d represents an average pore diameter of the micropores in the coal matrix, nanometers (nm); D represents an average pore diameter of the mesopores in the coal matrix, nm; σ_{gw} represents an interfacial tension between gas and the water, millinewtons per meter (mN/m); and θ represents a wetting angle of a surface of the coal matrix, degree (°).

5. The method for predicting the recovery factor of the deep coalbed methane as claimed in any one of claims 1-3, wherein the determining, based on an initially given value of a control volume, a corrected value of reservoir porosity and a corrected value of water saturation after fracturing flowback but before production comprises:
substituting the initially given value of the control volume into a fourth calculation formula and a fifth calculation formula respectively to calculate the corrected value of reservoir porosity and the corrected value of water saturation after fracturing flowback but before production; wherein the fourth calculation formula is expressed as follows:
$${ϕ}_{i p} = {ϕ}_{i} + \frac{{W}_{f i n} {B}_{w}}{V} ;$$
where φᵢₚ represents the corrected value of reservoir porosity, decimal; φᵢ represents an initial porosity of a coal reservoir, decimal; W_{fin} represents a net fracturing injection volume, 10⁶ m³; B_{w} represents the volume coefficient of water, m³/m³, with a value of 1; and V represents the initially given value of the control volume, 10⁶ m³; and
wherein the fifth calculation formula is expressed as follows:
$${S}_{w i p} = \frac{{ϕ}_{i} {S}_{wi} + \frac{{W}_{fin} - {B}_{w}}{V}}{{ϕ}_{i p}} ;$$
where S_{wip} represents the corrected value of water saturation, decimal; φᵢ represents the initial porosity of the coal reservoir, decimal; W_{fin} represents the net fracturing injection volume, 10⁶ m³; B_{w} represents the volume coefficient of water, m³/m³, with a value of 1; and φᵢₚ represents the corrected value of reservoir porosity, decimal.

6. The method for predicting the recovery factor of the deep coalbed methane as claimed in any one of claims 1-3, before determining, based on the initially given value of the control volume, the corrected value of reservoir porosity and the corrected value of water saturation after fracturing flowback but before production, further comprising:
substituting a total fracturing fluid volume during a fracturing process and a cumulative flowback volume during a flowback process into a third calculation formula to obtain a net fracturing injection volume; wherein the third calculation formula is expressed as follows:
$${W}_{fin} = {w}_{f i} - {W}_{fp} ;$$
where W_{fin} represents the net fracturing injection volume, 10⁶ m³; W_{fi} represents the total fracturing fluid volume during the fracturing process, 10⁶ m³; and W_{fp} represents the cumulative flowback volume during the flowback process, 10⁶ m³.

7. The method for predicting the recovery factor of the deep coalbed methane as claimed in any one of claims 1-3, wherein the calculating an iterative value of the control volume based on the physical parameters, the capillary pressure, the corrected value of reservoir porosity, the corrected value of water saturation, and the original gas in place of the reservoir, returning the iterative value of the control volume to replace the initially given value of the control volume for loop calculation, and stopping the loop calculation when a difference between values of the control volume from two adjacent iterations of the loop calculation is less than a preset value comprises:
substituting the physical parameters, the capillary pressure, the corrected value of reservoir porosity, the corrected value of water saturation, and the original gas in place of the reservoir into an eighth calculation formula to calculate the iterative value of the control volume; wherein the eighth calculation formula is expressed as follows:
$$V = \frac{{G}_{i}}{[ {ρ}_{c} \frac{{V}_{L} ( {p}_{i} + {p}_{c} )}{{p}_{L} + {p}_{i} + {p}_{c}} + \frac{{ϕ}_{ip} ( 1 - {S}_{wip} ) {Z}_{sc} {T}_{sc} {p}_{i}}{{p}_{sc} {Z}_{i} T} + {ϕ}_{ip} {S}_{wip} {C}_{s} {p}_{i} ]} ;$$
where V represents the iterative value of the control volume, 10⁶ m³; Gᵢ represents the original gas in place of the reservoir, 10⁶ m³; ρ_{c} represents the density of coal rock, t/m³; V_{L} represents the Langmuir volume, m³/t; p_{L} represents the Langmuir pressure, MPa; p_{c} represents the capillary pressure between the micropores and the mesopores in the reservoir, MPa; φᵢₚ represents the corrected value of reservoir porosity, decimal; S_{wip} represents the corrected value of water saturation, decimal; Z_{sc} represents the conventional gas deviation factor under the standard condition, dimensionless, with the value of 1; T_{sc} represents the temperature under the standard condition, K, with the value of 293.15; p_{sc} represents the pressure under the standard condition, MPa, with the value of 0.101325; pᵢ represents the initial coal reservoir pressure, MPa; T represents the coal reservoir temperature, K; Zᵢ represents a conventional gas deviation factor under the initial coal reservoir pressure, dimensionless; and Cₛ represents the solubility coefficient of the coalbed methane in the water, MPa⁻¹; and
returning the iterative value of the control volume to replace the initially given value of the control volume for the loop calculation, and stopping the loop calculation when the difference between the values of the control volume from two adjacent iterations of the loop calculation is less than the preset value.

8. The method for predicting the recovery factor of the deep coalbed methane as claimed in any one of claims 1-3, wherein the substituting the predicted value on the vertical axis into a prediction model established in a last iteration of the loop calculation to obtain a recoverable reserve of coalbed methane, and calculating the recovery factor comprises:
substituting the predicted value on the vertical axis into the prediction model established in the last iteration of the loop calculation to obtain the recoverable reserve of the coalbed methane; and
substituting the recoverable reserve and an original gas in place of the reservoir obtained in the last iteration of the loop calculation into a twelfth calculation formula to calculate the recovery factor of the coalbed methane, wherein the twelfth calculation formula is expressed as follows:
$${R}_{cbm} = \frac{{G}_{pab}}{{G}_{i}} ;$$
where R_{cbm} represents the recovery factor of the coalbed methane, G_{pab} represents the recoverable reserve of the coalbed methane, 10⁶ m³; and Gᵢ represents the original gas in place of the reservoir, 10⁶ m³.
